(19) United States
(12) Patent Application Publication
(10) Pub. No.: US 2024/0002258 A1
(43) Pub. Date: Jan. 4, 2024

(54) WATER RECLAMATION SYSTEM USING OIL AS A HEAT TRANSFER MEDIUM AND LIQUID SALT COLLECTOR

(71) Applicants: Erik Andrew Anderson, Lake City, MN (US); Carlos Alberto Salazar, Bakersfield, CA (US)

(72) Inventors: Erik Andrew Anderson, Lake City, MN (US); Carlos Alberto Salazar, Bakersfield, CA (US)

(21) Appl. No.: 17/810,475

(22) Filed: Jul. 1, 2022

(51) Int. Cl. C02F 1/04; C02F 1/06; C02F 1/26; B01D 11/04; B01D 1/00

(52) U.S. Cl. CPC C02F 1/048; C02F 1/06; C02F 1/265; B01D 11/0492; B01D 1/0052; B01D 1/007; C02F 2103/08

(57) ABSTRACT

A system and process for recovering pure water and salts from wastewater using oil as a heat transfer medium and liquid salt collector. The wastewater is treated separately so that plant water and potable water result in separate brine streams that are subsequently combined prior to having the heated oil transferred thereto before entering an evaporator. The heated oil vaporizes the pure water in the evaporator and carries the salts from the evaporator as the salts are insoluble in the oil.

### BACKGROUND OF THE INVENTION

The present invention relates to water reclamation systems and, more particularly, a system and process for recovering pure water from wastewater and saltwater using oil as a heat transfer medium and liquid salt collector.

World-wide water use has become a major issue, both in agriculture and as a source of clean drinking water. In the United States, aquifers are being recorded at all-time lows with consequences affecting food and utility prices. Two types of water scarcity have been defined: physical or economic water scarcity. Physical water scarcity is where there is not enough water to meet all demands, including that needed for ecosystems to function effectively. Arid areas, for instance, often suffer from physical water scarcity. Alternatively, economic water scarcity is caused by a lack of investment in infrastructure or technology to draw water from rivers, aquifers, or other water sources, or insufficient human capacity to satisfy the demand for water.

Separately, agricultural, and industrial water run-off is recently being looked at as a major source of water contamination. The fertilizers and nutrients added to irrigation systems and fed to plants can have negative effects on local and regional water resources. Resulting in regulation forcing farmers and companies to reduce their water discharge and, in turn, reduce the amount of alkali and metal-based salts they send to rivers and oceans, which is critical to reversing the effects of human terraforming.

The negatives of salt runoff on rivers and oceans have been well studied i.e., hypoxia zones, high pH (alkalinity), algae blooms, etc. In addition to damage to the environment, the nutrients, and salts themselves are limited resources and cannot be recovered once they reach the ocean. Critical fertilizer nutrients like phosphates, nitrates and potassium are in limited supply and require, currently faltering, global supply chains to maintain domestic agricultural operations. If these compounds are not recovered before entering rivers and oceans, they are unable to be recovered economically.

To be sure, technologies aimed at reducing wastewater discharge can and do use water evaporation systems but are not able to recover all the water. These systems only concentrate the salt solutions to a point, while maintaining a residual liquid phase to make it easier to discharge the concentrated salt solution.

Moreover, current so-called ‘zero water discharge systems’ suffer from material handling and fouling issues. Specifically, the dried material can be corrosive to metals and erode liners and other supporting materials. Build-up of and plugging of equipment because of salts can cause routine failure and reduce continuous run-time.

As can be seen, there is a need for a system and process for recovering pure water from wastewater and saltwater using oil as a heat transfer medium and liquid salt collector.

Using oil as the heat transfer medium and as the salt separation medium allows the salt to be removed from the system immediately following water evaporation. Most salts are insoluble to a high degree in oil and so can be recovered via filtration, centrifugation, or gravity separation, with little residual salt remaining. Therefore, utilizing the proposed water and salt recovery technology would allow for the economical collection of all salts and inorganics before being released to water treatment systems.

Currently there is no other technology on the market that offers the same benefits as the present invention which embodies a process of using oil as a heat transfer medium and liquid salt collector. As the water is converted to steam, the salts are left behind to be carried away and filtered from the oil as a solid.

The disclosed system can separate any filtered wastewater system laden with inorganic salts and minerals from reverse osmosis or fertilized agriculture into its individual water and salt components. This significantly reduces the amount of water discharged by companies and municipalities, while simultaneously removing the salts and minerals as a solid material. The salts are kept from entering larger water systems like rivers and oceans, and the water can be recycled for immediate use.

Additionally, these systems sacrifice a percentage of the water (residual liquid phase) to leave the salts in a pumpable state for material handling reasons. Using oil as the heat medium and as a salt separation medium allows the salt to be removed from the system immediately following water evaporation. Most salts are insoluble to a high degree in oil and can be recovered via filtration, centrifugation, or gravity separation, with little residual salt remaining.

In short, utilizing the water and salt recovery technology disclosed herein would allow for the economical collection of all salts and inorganics before being released to water treatment systems.

### SUMMARY OF THE INVENTION

In one aspect of the present invention, a water reclamation system includes a flash evaporator employing an oil, renewable or otherwise, as both a heat-medium and as a salt/metal mobile phase.

In another aspect of the present invention, the water reclamation system includes wherein an input stream of the flash evaporator is brine water, wherein the input stream is a combination of a potable water brine stream and a plant run-off stream, wherein each is an output of a separate reverse osmosis scheme, respectively, wherein the oil is transferred to the input stream immediately to it entering the flash evaporator, and wherein in some embodiments the renewable oil is refined vegetable oil.

In yet another aspect of the present invention, the water reclamation system includes the following: a flash evaporator employing an oil as both a heat-transfer medium and as a salt-carrier phase, wherein an input stream of the flash evaporator is salt concentrated solution, wherein the salt concentrated solution is a combination of a potable water brine stream and an output plant water stream, wherein each stream is an output of a separate reverse osmosis scheme, respectively, wherein the oil is transferred to the salt concentrated solution prior to it entering the flash evaporator, wherein the oil is refined vegetable oil or a non-renewable petroleum-based oil, and wherein the flash evaporator is configured to force substantially all salts from the salt concentrated solution into the oil, wherein the salts are substantially insoluble in the oil, wherein the oil is sufficient pre-heated to convert a water portion of the salt concentrate solution into steam, and wherein the potable water brine stream is fed back to an input plant water stream prior to its respective reverse osmosis scheme.

These and other features, aspects and advantages of the present invention will become better understood with reference to the following drawings, description, and claims.

### BRIEF DESCRIPTION OF THE DRAWINGS

FIG. 1 is a schematic view of an exemplary embodiment of the present invention, illustrating a filtration and chemical treatment process.

FIG. 2 is a schematic view of an exemplary embodiment of the present invention, illustrating a reverse osmosis process.

FIG. 3 is a schematic view of an exemplary embodiment of the present invention, illustrating a flash evaporator and nutrient recovery process.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, an embodiment of the present invention provides a system and process for recovering pure water and salts from wastewater and saltwater using oil as a heat transfer medium and a liquid salt collector.

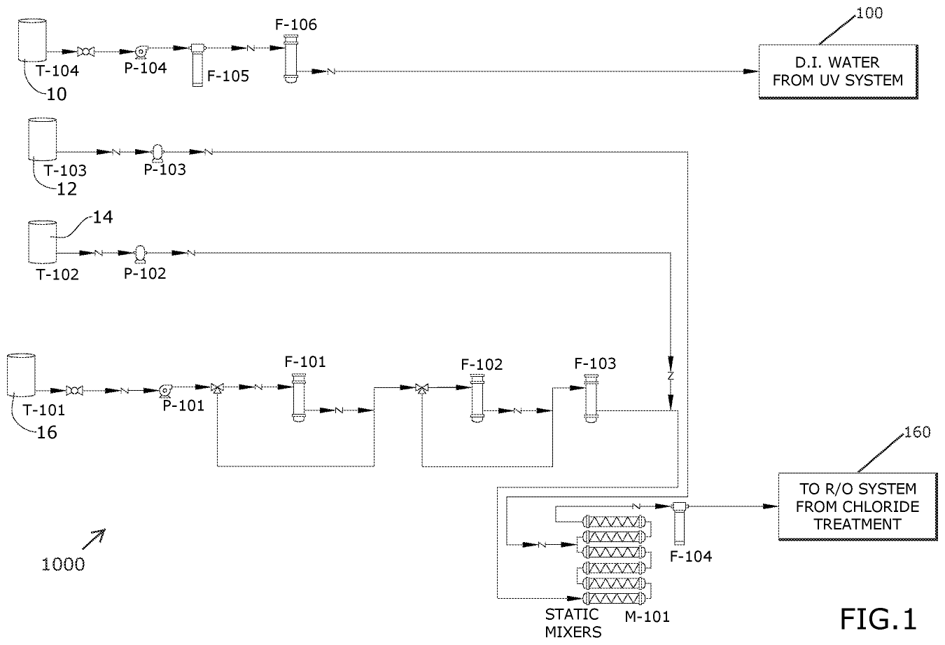

Referring now to FIG. 1, a first stage of the disclosed process may include a multi-filtration and chemical treatment scheme 1000. A plurality of wastewater streams can be introduced to the filtration and chemical treatment scheme 1000: (1) plant water 16, which includes effluent, agricultural, and/or hydroponic plant water run-off that may contain residual nutrients and minerals from fertilizers; and (2) condensed water 10, typically HVAC recovery water that may contain bacterial growth. The individual streams are filtered according to need, through a series of filters of decreasing sizes, such as cartridge, bag or other filters, and activated carbon filters.

Including but not limited to the plant water 16 being filtered through F-101, F-102, and F-103. Sulfuric acid 14 may be injected into plant water stream for pH control purpose just prior to that stream being subject to static mixers M-101. Within the static mixers M-101, antiscalant 12 may be added to the plant water stream, which culminates in plant water (chloride treated) output 160. In certain embodiments, the condensed water may pass through condensed DI water filters F-105 and F-106, which culminates in D.I. water 100, to be used in a third stage of the process.

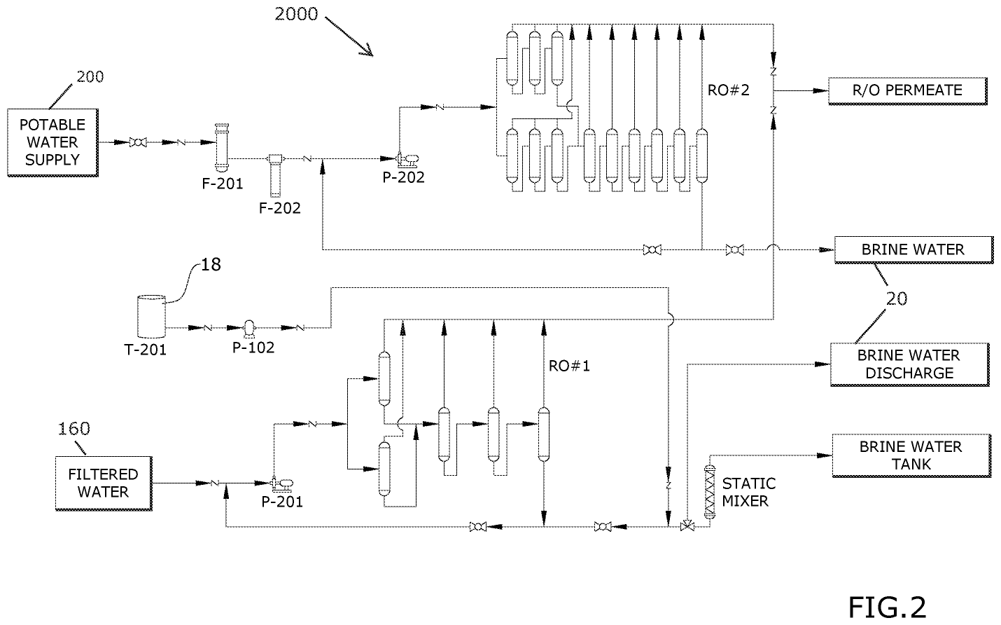

Referring now to FIG. 2, a second stage of the disclosed process may include one or more reverse osmosis schemes 2000. The reverse osmosis scheme 2000 may incorporated two steams: (1) the plant water output 160 from the multi-filtration and chemical treatment scheme 1000; and (2) city, municipal or well (potable) water supply 200. Each input stream may be sent to individual reverse osmosis systems 2000, respectively. Note, the potable water may first pass through filters F-201, and F-202.

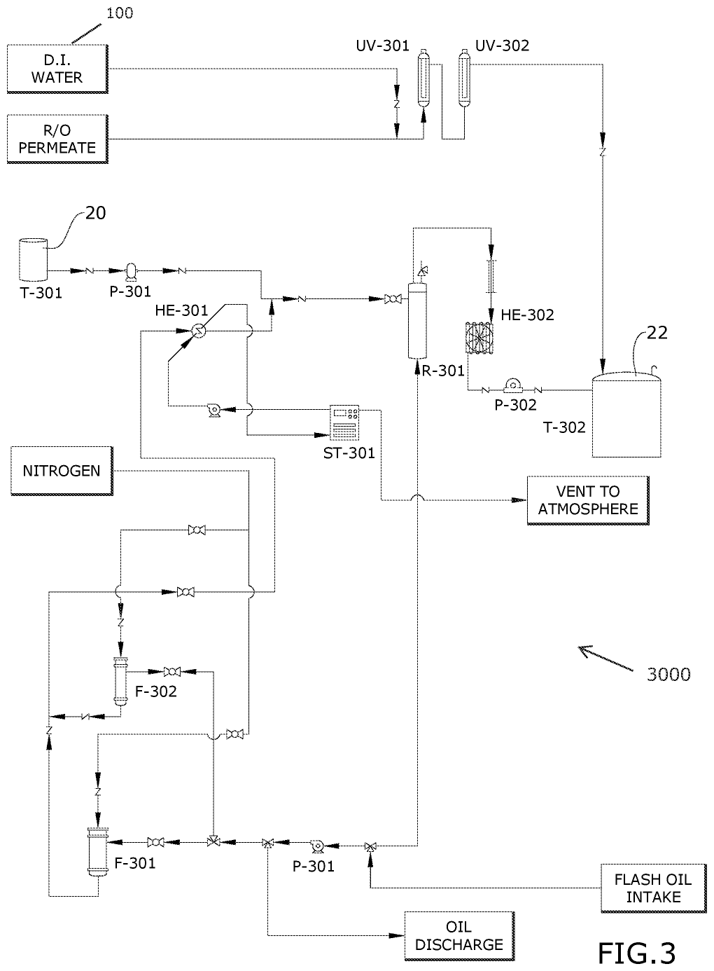

Due to their unique analyte profiles, the salt laden concentrate water or brine water 20 that is discharged from the city or well water reverse osmosis scheme 2000 can be recycled back into the holding tank for plant water run-off feed supply 16. Therefore, the city or well supplied water is fed to reverse osmosis and produces two streams, a clean permeate water and a salt concentrate solution. The salt concentrate is mixed with the filtered plant run-off water prior to reverse osmosis. This second reverse osmosis system produces another clean permeate stream and a final brine concentrated water stream, is salt laded and is the feed to the flash evaporator for water recovery and salt separation. All the actions above can be performed continuously or broken up into multiple batch processing by the one or more reverse osmosis schemes 2000. Referring now to FIG. 3, a third stage of the disclosed process may include a flash evaporator and nutrient recovery process 3000. The brine concentrated water stream 20 (from the one or more reverse osmosis schemes 2000) may be combined with plant water output 160 (held in a holding tank after scheme 1000), This resulting salt laden solution is fed to the flash evaporator.

The flash evaporator and nutrient recovery process 3000 can be done continuously or batch-wise, depending on the process design. The brine water 20 is mixed in-line with a circulating loop of high-temperature renewable oil. The renewable oil can be made up of multiple renewable oil products like vegetable oil and other oleochemicals. The hot oil stream heats the water before it enters the flash reactor, which thermally converts the water to steam that leaves the reactor out the top. The salts the water carried into the reactor are forced into the renewable oil phase and carried out of the bottom of the reactor. From the reactor, the salts are pumped through a filtration system and/or settling tank where the insoluble salts are separated from the renewable oil. The salts can be collected as a filter cake or solid and either processed further to recover certain high-value components or disposed of as a volume reduced, water-free, non-hazardous waste product. Periodically or continuously, the salts are purged from the oil phase while the steam is condensed outside of the reactor as pure, distilled water.

The purpose of the multi-filtration and chemical treatment scheme 1000 is to remove all significant amounts of dissolved solids in all water streams being processed—plant water 16, municipal or well water, and condensed water 10. The multi-filtration and chemical treatment scheme 1000 may include filters arranged from high micron porosity to low micron porosity. In this way, the larger particles are collected first, while the smaller particles are collected in the secondary and tertiary filters. The final filter contains activated carbon, with a micron porosity greater than the previous filter. The intention is that the activated carbon filter should not be utilized as a dissolved solids filter, but rather a high surface area filter that traps nonmetals such as chlorine. Prior to entering the system, the condensed water 10 (HVAC recovery water) may be held in a storage tank and connected to a pump on the skid, that is how it enters the process. Note, a skid is a term used to describe any system built on top of a metal framework. The framework or “skid” is what all the components are mounted to and can be used as a base to move the entire system. The water stream may be sent through two filters, a 1-micron filter and a 5-micron activated carbon filter. From there the water is sent to be sterilized via continuous flow, UV lamps, and the like.

The one or more reverse osmosis schemes 2000 embodied by the present invention is part of the order of operations relative to flow sequencing that is novel and may be critical for the disclosed process and system to work. In the one or more reverse osmosis schemes 2000, the city or well water stream may be processed separately from the plant run-off water, wherein there is a discharge stream from each reverse osmosis scheme 2000: permeate (clean water) and brine water (salt concentrate). The nuance of the system of the present invention may be that the brine (salt) water generated during reverse osmosis of city or well water is sent to the plant run-off water holding tank.

The combined water streams are then sent through the initial filtration stages associated with the plant run-off water. Because the minerals and metals found in city and well water are different from the minerals and metals found in the plant run-off water, there is no decreased performance in the second reverse osmosis system. Membrane failure rates are determined by over throughput of individual analytes; therefore, the addition of the city water brine stream 20 does not affect the lifetime of the second reverse osmosis membranes.

The flash evaporator and nutrient recovery process 3000 provides at least one flash evaporator that may be a self-contained water evaporator that uses a renewable oil (refined vegetable oil or the like) as both a heat-medium and as a salt/metal mobile phase. As the brine water enters the skid, it is combined in-line with the hot oil. Sensible and latent heat are transferred to the water immediately before the mixture enters the flash evaporator. The water portion of the mixture is converted to steam at temperatures above boiling water (˜280 F). The salts that were carried into the reactor and soluble in the water phase are no longer soluble in the oil phase. The oil and salt mixture are carried out of the reactor via liquid pump. After the pump, the salt and oil mixture are sent through a salt/oil separation system (filter or gravity separation tank). The clean, salt free oil continues to a heat exchanger, which will provide the thermal energy required to heat the oil phase back up to the required design temperature.

### Control Loop Strategy—Description of Wastewater Process Telemetry

### Start-Up and Shutdown Initiators

Once power is brought to the system and energized, a systemic control screen may prompt a user. The starting of the three stages: the multi-filtration and chemical treatment scheme 1000, and the HVAC water recovery and city well or municipal water reverse osmosis scheme 2000 can be initialized several different ways. The first is a pre-set timed startup procedure, the second may be a significant rise in liquid level inside either T-101 or T-104, or third a manual start-up by an operator. Shutting down the system can be controlled similarly to the startup criteria, a pre-set timed shut off, Stagnation of T-101 or T-104 for over a pre-set time, and a manual or remote shutdown performed by an operator. As each individual system component (‘plant’ water filtration, HVAC water recovery, and city well water) starts, it will strive to achieve a pre-set input flow set point, in gallon per minute (GPM), in all feed lines. The system may prioritize which source of water is drawn from to make up the pre-set total flow requirements. First priority may go to the HVAC water source, the second is the municipal or well water source. The filtered water or plant effluent water is processed as needed.

### Utilities—Heating and Cooling

The flash evaporator requires both heating and cooling components. As the need for filtered water is triggered and activates P-101, the flash evaporator will begin by circulating both its process side pump (P-301) and its heating utility pump (P-303). While starting the flash pumps, a three-way actuated valve (AV-301) may be maintained in a position which sends the discharge to the T-101. Once the pumps reach their setpoint parameters (line pressure), the heat source will be activated and raise the process liquid to its temp set point, controlled by the temperature transmitter, TT-303. Once the flash has reached its set point temp, the cooling fan used to condense the bulk of the steam will also start. Once the flash evaporator reaches steady-state (heating and cooling), the AV-301 will switch its position, rerouting the brine discharge water to enter the flash evaporator.

### Normal Operation

An exemplary multi-filtration and chemical treatment scheme 1000:

The primary pump that controls the flow of ‘plant’ effluent through the filtration system (P&ID #1) is P-101. As the level in the ‘plant’ water holding tank (T-101) rises 15% above its preset point, in gallons, it initiates P-101 to start and maintain the level inside T-101 at its current level, 15% above the preset value. When the facility stops producing plant water, the pump will continue until the level goes down to the original preset gallons. The feed pump, P-101 must have a programmable flow rate of X.XX GPM, as determined by FT-101. If the flow rate stays above or below the programed “ideal” setpoint for more than 20 seconds, then a ‘malfunction’ warning should signal at the control box and via a software application.

AV-101 is the first valve leaving the ‘plant’ water holding tank. It should open at the beginning of operation (when the system is activated) and shut off when the system is turned off.

The first filters in the process are F-101, F-102, and F-103. There may be a total of four pressure transmitters surrounding and in between each filter (PT-101, PT-102, PT-103). The differential pressures across all filters will be calculated, along with the total differential pressure across all three filters. When the differential pressure across either of the first two cartridge filters in the series (F-101 and F-102) rises above the max diff. pressure (25 psi) and maintained for longer than 10 seconds, it signals the electric 3-way valve to actuate, rerouting the flow around the blocked filter. This in turn will initiate a signal to the HMI and mobile application, notifying the user and system which filter needs to be changed. If both filters are If one filter is still in by-pass mode when the second meets the by-pass criteria, then the “plant filtration’ component will halt and go into stand-by. Operation confirmation is needed to continue once filters have been changed.

A five-micron filter may come after the static mixer array, F-107. When the differential pressure across PT-104 and PT-201 rises above the max pressure (30 psi) and is maintained for longer than 10 seconds, it signals the HMI and mobile app that the filter needs to be replaced.

The sulfuric acid feed pump (P-102) is controlled by a VFD, set to programmable flowrate based on the flow rate of FT-101. The flow-rate calculation or “function” for the flowrate of P-102 is FT-101 (in GPM) multiplied by 8.34 lbs/gal, multiplied by the programmable sulfuric acid charge set-point, XXX (in pounds per minute, PPM). The pH transmitter (pHT-101) will confirm the effectiveness of the acid flow rate. The pH set point should be approx. 6.0, with data logging and warnings indicating when outside of range.

The antiscalant feed pump (P-103) is controlled by a VFD, set to programmable flowrate based on the flow rate of FT-101. The pump should not activate until FT-101's flow rate reaches a minimum of 4 GPM. The function for the flowrate of P-103 is: FT-101 (in GPM) multiplied by 8.34 lbs/gal, multiplied by the programmable antiscalant charge set-point, XXX (in ppm).

Separate from the reverse osmosis operation is the recovery of condensed water from the building's HVAC system. The condensed water is pumped from a holding tank using P-104, through two filters, a 5 micron single cartridge filter (F-105) and a 5 micron carbon filter (F-106). Pump activation is controlled by the level transmitter (LT-104), located on the condensed water holding tank, T-104. As the level rises 15% above a programmable set point, it activates the pump (P-104). The pump speed is ramped up to a programmable set point, X.XX gpm, as determined by the flow transmitter, FT-102, until the level begins to reduce. The opposite relationship applies when the liquid level falls back down to its setpoint, shutting down the pump. Two pressure transmitters (PT-107 and PT-108) are used to monitor the differential pressure above and below the first filter (F-108). When the differential pressure goes beyond its setpoint and is maintained for 10 seconds, it alerts a warning on the HMI and activates a light indicator somewhere on the skid. The second filter's status is determined using a combination of PT-108 and FT-102. If there is a pressure reading on PT-108 greater than 30 psi OR FT-102 falls below its set point, a warning light and signal will indicate that F-109 is plugged.

The actuated valve, AV-103, may be opened and closed at the beginning and end of system operation

A plurality of UV lamps may be used to kill microorganisms on two separate lines, the condensed water recovery line and after reverse osmosis. Each UV lamp should turn on as a function of the DI water feed pump (P-104) activation.

An exemplary reverse osmosis scheme 2000:
The filtered water stream (line #2001) entering reverse osmosis on P&ID #2 is fed directly into its own reverse osmosis system, starting with the RO pump, P-201. The pump speed is set manually during the initial system set-up, using the manual control valves, CV-201 and CV-202 and the brine, brine recycle, and permeate Flow Indicators, FI-201, FI-202, FI-203. Once the correct flows are established the system is monitored using PT-202. As the pressure increases beyond a high-high setpoint, indicating the reverse osmosis is blocked, then it should signal P-101 AND P-201 to stop the primary flow and RO pump. In addition, an HMI warning will indicate the RO system is blocked and either needs to be flushed or have membranes replaced.

The flow of city water begins with the opening and closing of AV-201 and the flow rate (and totalizer) may be measured and recorded using FT-202. The flow setpoint for FT-202 is determined by the overall required flow setpoint, minus FT-201. In this way, the system operator will establish a single system flow rate, with the city water making up the difference between filtered water and overall flow rate. The differential pressure across F-201 may be determined using PT-203 and

PT-204. When the differential pressure across the filter goes beyond its max (25 psi) and is maintained for 10 seconds, it alerts a warning on the HMI/mobile app and activates a light indicator somewhere on the skid. A second indicator for F-202 is when PT-204 reaches a max pressure of 30 psi OR the city water flow (FT-203) falls below its set point when fully open.

Like the filtered water RO system, the city water RO pump (P-202) speed is set manually during the initial system set-up, using the manual control valves, CV-203 and CV-204 and the brine, brine recycle, and permeate Flow Indicators, FI-204, FI-205, FI-206. Once the correct flows are established the system is monitored using PT-202. As the pressure increases beyond a high-high setpoint, indicating the reverse osmosis is blocked, then it should signal P-202 to stop and AV-201 to close. In addition, an HMI warning will indicate the RO system is blocked and either needs to be flushed or have membranes replaced.

There may be three streams leaving the two reverse osmosis schemes 2000, a purified permeate stream and two salt laden brine streams. The permeate stream has a flow transmitter/totalizer (FT-204) and a conductivity probe (CI-204), both which should be recorded for data analysis. The city water brine stream's flow rate is measured manually using the Flow Indicator, FI-204, while the filtration stream's permeate and brine flowrates are measured manually using Flow Indicators FI-203 and FI-201, respectively.

Multiple function driven calculations must be reported on the HMI, using the flow rates and conductivity readings of the incoming material and the permeate discharge.

Salt Rejection %=(CI-201-CI-202)/(CI-201)*100(Filtered Water)

Salt Rejection %=(CI-203-CI-204)/(CI-203)*100(City Water)

Salt Passage %=(1−Salt Rejection %)

% Recovery=(FT-202)/(FT-101+FT-201)*100

Concentration Factor=1/(1−% Recovery)

Flux=(FT-101*720 mins/day)/#RO units in each system*sqft of each membrane(Filtered Water)

Flux=(FT-201*720 mins/day)/#RO units in each system*sqft of each membrane(City Water)

An exemplary flash evaporator and nutrient recovery process 3000:
The water flow coming into the third P&ID is composed of salt laden brine water. It flows passively through the first heat exchanger, HE-301. The temperature before and after the HEX is monitored and recorded using TT-301 and TT-301. Once it's preheated, the water combines with the thermal oil circulation loop before entering the flash evaporator. The combined stream's temperature is controlled and recorded prior to entering the flash evaporator using TT-303. On the utility side of HE-302 is a second thermal oil loop, heated by the system's thermal oil boiler. The boiler itself will control the temperature set point using the temperature transmitter, TT-303, as its reference point.

The flash evaporator may have a pressure transmitter (PT-301) mounted to its top portion (in the vapor space). The pressure transmitter will report the reactor's pressure and signal a warning and system shut down if pressures exceed a high warning and a high-high warning, respectively.

The liquid level of the flash evaporator will be controlled by 3 level switches, LSH-301, LSN-302, and LSL-303. Upon filling of the vessel (done offline), the renewable oil level will be pumped into the vessel until both level switches LSL-301 and LSN-302 are activated. When operating correctly, the fixed volume of thermal oil should not change. If the LSN-302 is disengaged during operation, this means that the thermal oil is being carried away with the flashing water and that more oil needs to be replaced, either through automation or manually. In this scenario, a system warning must signal the operator to either add additional oil or to communicate that the system is being filled automatically. The activity must be logged. If the LSH-303 is engaged during operation, this implies that the water is not evaporating completely, allowing it to build-up in the evaporator. If this happens, then the flow from the primary feed pump P-101 must be slowed or stopped. If P-101 is stopped and the LSH-303 does not disengage after approximately three minutes of operation, then the filtered water supply, controlled by P-101 and P-201, must also be stopped. Once all water supplies have been shut-off, the flash evaporator will continue to circulate until LSH-303 is disengaged. If LSH-303 does not become disengaged after 10 min, then an HMI warning will flash indicating that the heat transfer of HE-302 is insufficient. At this time the flash evaporator portion must be shut down immediately and the heat exchanger (HE-302) must be serviced for salt build-up or filter F-301 must be cleaned.

The thermal oil circulation line on the flash evaporator may contain a slip-stream filter (F-301) with two pressure transmitters upstream and downstream (PT-302 and PT-303). Like the filters in previous examples, the transmitters will track both the line pressure and the differential pressure across the filters. When the differential pressure goes beyond its setpoint and is maintained for 10 seconds, it alerts a warning on the HMI and activates a light indicator somewhere on the skid and tells the operator that the filter must be changed.

A method of manufacturing the system embodied in the present invention requires a combination of equipment, instrumentation, controls system, reactors, and storage tanks. Fabrication of the system in its entirety would require multiple disciplines, including but not limited to metal fabrication, electrical engineering, controls specialists, pipe fitters, mechanical and chemical engineering. Following the piping and instrumentation drawings provided, each component (sensor, transmitter, pump, heat exchanger, reactor, etc.) must be specified and supplied for the defined operating parameters (pressure, temperature, material of construction, electrical supply, etc.). The skid and reactor are built using common metal fabrication techniques i.e., MIG and TIG welding, pipe fitting, tank rolling, cutting, bending and bolting. The supplied electrical power and subsequent instrument control power are designed by certified electrical engineers and built by qualified technicians. The process piping is a mixture of stainless steel and PVC. Pipe fitters are employed to guarantee the outcome will meet the operational needs of the system. Mechanical and chemical engineers are required to dictate the appropriate equipment, instruments, and materials of construction required for a system of a given size function properly. Engineering and design of each system, unique to their facilities size, layout, power availability, and water requirements, is performed by a combination of engineering disciplines. The selecting and sourcing of components is a requirement for optimal performance. Aside from the electrical requirements, the flash evaporator requires a significant thermal load and cooling capacity. The thermal load can be supplied using multiple energy sources i.e., electrically generated heat, natural gas, propane, and/or co-generation of heat using a renewable, biomass derived energy source

The system can be considered three water treatment systems in one, wherein the three streams are 1) city or municipal supply water 2) ‘plant’ run-off water and 3) HVAC recovery water. Each individual stream can operate independently of the other two. The system's control sequence allows the system to prioritize using the city or municipal water supply as ‘makeup’ water last, choosing to utilize the recovery streams first.

Each stream goes through a unique engineered process sequence, based on the expected water profile its carrying. The sequence can be characterized into three steps: filtration, reverse osmosis, and flash evaporation and sterilization. The sequence stages must be performed chronologically (1->2->3) or it will cause system failure. Reverse osmosis can only be performed on heavily filtered materials and likewise, flash evaporation can only be performed on the reverse osmosis brine discharge volumes.

Additional chemical treatments can also be added to the skid design, including but not limited to caustics, acids, antiscalants, chlorine, and chlorine derivative additions.

The flash evaporation system can be modified in multiple ways to tailor its function to unique applications. The distillation of water can be achieved using multiple reactor designs and can be accomplished at atmospheric pressure or under vacuum pressure. Separation of the solids can be achieved using multiple technologies i.e., filtration, centrifugation, and gravity separation. The sequence of salt separation, heating, and saltwater combination can be modified to fit a variety of situations and purposes.

A method of using the present invention may include the following. The system disclosed above may be provided. A user in need of water treatment and reclamation would have the system delivered and assembled onsite according to the facilities utility and special tolerances. Once installed, the operator and new owner would be trained in the system operation and all relevant maintenance. They would be shown how to power ON the system, traverse the controls and command sequences on the systems control panel. Assuming the system was installed correctly, and all ‘startup’ procedures have been performed e.g., pre-filling the pipes and instruments with water and the flash evaporator with renewable oil, the system can be started. Once started, the system should operate continuously until a filter plugs or the reverse osmosis membranes need replacing. Expected events like filter and membrane replacement will be announced to the operator and to the provider, to improve response time as well as track and analyze operating data in real-time. Operators may also be prompted to perform semi-automated, pre-programmed sequences for start-up, shutdown, and refreshing of the mobile oil phase. Standard Operating Procedures (SOPs) will be provided both on-screen and in paper form, located on the equipment itself.

Additionally, the above-mentioned process can be modified and applied to almost any application that seeks to remove water from a concentrated salt solution. At low concentrations of salt or metals reverse osmosis alone can reduce wastewater (brine) volumes. The concentrated wastewater or brine solutions must then be either discharged to a sewer system or sent to a zero liquid discharge system for actual complete water recovery.

Aside from the primary product—i.e., reclaimed distilled water—the present invention may form other products during operation, such as solid, dry salt mixture. The composition of the salt mixture is based on the neutralized metals and nonmetals present in the initial source water, plus any fertilizers or minerals added to the water to improve its use in agricultural plant growth. Additional processing of the solid salt discharge has the potential to reclaim valuable nutrients and/or minerals for reuse as fertilizers.

Another useful by-product of the process of the present invention is available waste heat. As steam is produced during the process, condensing the steam can be performed using a passive heat exchanger. The energy removed from the system can be routed through several heat exchanger pathways for multiple uses e.g., heating buildings, warming water sources, process heat for other utilities.

As used in this application, the term “about” or “approximately” refers to a range of values within plus or minus 10% of the specified number. And the term “substantially” refers to up to 80% or more of an entirety. Recitation of ranges of values herein are not intended to be limiting, referring instead individually to any and all values falling within the range, unless otherwise indicated, and each separate value within such a range is incorporated into the specification as if it were individually recited herein.

The use of any and all examples, or exemplary language (“e.g.,” “such as,” or the like) provided herein, is intended merely to better illuminate the embodiments and does not pose a limitation on the scope of the embodiments or the claims. No language in the specification should be construed as indicating any unclaimed element as essential to the practice of the disclosed embodiments.

In the following description, it is understood that terms such as “first,” “second,” “top,” “bottom,” “up,” “down,” and the like, are words of convenience and are not to be construed as limiting terms unless specifically stated to the contrary.

It should be understood, of course, that the foregoing relates to exemplary embodiments of the invention and that modifications may be made without departing from the spirit and scope of the invention as set forth in the following claims.

What is claimed is:

1. A water reclamation system, the system comprising:
a evaporator employing an oil as both a heat-transfer medium and as a salt-carrier phase.

2. The system of claim 1, wherein an input stream of the evaporator is salt concentrated solution.

3. The system of claim 2, wherein the salt concentrated solution is a combination of a potable water brine stream and an output plant water stream, wherein each stream is an output of a separate reverse osmosis scheme, respectively.

4. The system of claim 3, wherein the oil is transferred to the salt concentrated solution prior to it entering the evaporator.

5. The system of claim 4, wherein the oil is refined vegetable oil.

6. The system of claim 4, wherein the oil is a petroleum-based oil.

7. The water reclamation system of claim 2, wherein the evaporator is configured to force substantially all salts from the salt concentrated solution into the oil.

8. The water reclamation system of claim 7, wherein the salts are substantially insoluble in the oil.

9. The water reclamation system of claim 7, wherein the oil is sufficient pre-heated to convert a water portion of the salt concentrate solution into steam.

10. The water reclamation system of claim 3, wherein the potable water brine stream is fed back to an input plant water stream prior to its respective reverse osmosis scheme.

11. A method of reclaiming a pure water and a salt concentrated solution, the method comprising using an oil as both a heat-transfer medium to the salt concentrate solution for vaporizing said pure water and as a carrier of said salt insoluble in the oil.
